(19) United States
(12) Patent Application Publication
(10) Pub. No.: US 2024/0381846 A1
(43) Pub. Date: Nov. 21, 2024

(54) DOG CO-WALKING LEASH

(71) Applicant: Sporn Pet Products, Inc., New York, NY (US)

(72) Inventor: Joseph SPORN, New York, NY (US)

(21) Appl. No.: 18/669,342

(22) Filed: May 20, 2024

Related U.S. Application Data
(60) Provisional application No. 63/467,654, filed on May 19, 2023.

(51) Int. Cl. A01K 27/00

(52) U.S. Cl. CPC A01K 27/005; A01K 27/003

(57) ABSTRACT

An improved leash allows a child/partner and an adult to walk a dog at the same time using the same co-walk leash. The leash has a primary handle connected to a primary leash section and a secondary handle connected to a secondary leash section. The secondary leash section is shorter than the primary leash section. A top portion of a common leash section may be connected to both an end of the primary leash section and an end of the secondary leash section. A harness connection may be connected to the bottom of the common leash section. A shock absorbing section may be added to the end of the primary leash section and/or the secondary leash section. Means may be provided for connecting the primary leash section with the secondary leash section. Means may be provided for separating the common leash section into two separate linear pieces.

### CROSS-REFERENCE TO RELATED APPLICATIONS

This patent application is related to and claims the benefit of U.S. Provisional Patent Application No. 63/467,654 filed on May 19, 2023, titled Dog Co-Walking Leash, which is hereby fully incorporated by reference.

### FIELD OF THE INVENTION

The present invention relates to an apparatus to be used while walking a dog and more particularly to a leash that allows one or two individuals, such as an adult, an adult and a partner or an adult and a child, to safely walk a dog together.

### BACKGROUND

Apparatus specifically designed to control and walk a dog are known. For example, a dog harness is a piece of equipment comprising one or more straps that surround the dog's torso. The harness may be used to control the movements of a dog in a safe and humane manner. The harness may reduce undesirable tension on the neck of the dog while maintaining freedom of movement for the dog. The harness may also be designed to efficiently utilize a dog's pulling power, without hurting the dog.

A leash, sometimes referred to as a lead, lead line or tether, may be attached to the harness and used by a human to guide and control the dog. The leash may be made of one or more different materials, such as rope, leather or chain. The length of the leash controls the maximum distance the dog can be from the human holding the leash. The human may control the movements of the dog through movements of the leash (and possibly voice commands). With practice and training (of both the human and the dog), the human may exercise a great deal of control over the movements of the dog with small and controlled movements from the leash.

### SUMMARY OF THE INVENTION

Accordingly, the invention is directed to a leash that allows two people jointly to safely walk a dog when one of the people lacks the size, strength, or technique needed to walk the dog alone; additionally, the leash can be used by a single capable person. In various examples, an adult, an adult and a partner or an adult and a child can use the leash to safely walk a dog.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

Embodiments of the present invention allow two people to walk a dog with a co-walk leash. The co-walk leash has a primary handle, intended for use by a child or another adult, connected to a primary leash section. The co-walk leash also has a secondary handle, intended for use by an adult, connected to a secondary leash section. In preferred embodiments, the secondary leash section is shorter than the primary leash section. A top portion of a common leash section may be connected to a distal end of the primary leash section and a distal end of the secondary leash section. A harness connection may be connected to a distal end of the common leash section for connecting to a harness or collar of a dog.

In some embodiments, a shock absorbing section may be added near or at the distal end of either the primary leash section or the secondary leash section or to both sections.

In some embodiments, a means is provided for connecting the primary leash section with the secondary leash section, such as by attaching a male buckle to the primary leash section and a female buckle to the secondary leash section or vise versa. This allows the co-walk leash to be used by one person without one of the handles being dragged along the ground as the dog is walked.

In some embodiments, the primary leash section, secondary leash section and the common leash section are each formed from a single non-separable linear piece of material (such as a rope or nylon webbing).

In other embodiments, the common leash section may be formed from two separable linear pieces of material (such as rope or nylon webbing) where Velcro is attached along all or some portion of the two separable linear pieces of material. This allows the common leash section to actually be two separate portions of the co-walk leash when the Velcro sections are not connected or the common leash section may be one linear piece of material when the Velcro sections are connected.

In other embodiments, the Velcro may be attached to the inside surface of the primary leash section and the inside surface of the secondary leash section. This gives the options of connecting or not connecting portions of the primary leash section with the secondary leash section.

The embodiments with Velcro or other means of attachment allow the length of the primary leash section, the secondary leash section and the common leash section to be varied, by adjusting (pressing different parts of the co-walk leash together) which portions of the leash are Velcroed together.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a co-walk leash apparatus arranged in accordance with an example embodiment of the present invention;

FIG. 2 is another perspective view of the co-walk leash apparatus arranged in accordance with the example embodiment of the present invention illustrated in FIG. 1;

FIG. 3 is a front elevation view of the co-walk leash apparatus arranged in accordance with the example embodiment of the present invention illustrated in FIG. 1;

FIG. 4 is a back elevation view of the co-walk leash apparatus arranged in accordance with the example embodiment of the present invention illustrated in FIG. 1;

FIG. 5 is a left side elevation view of the co-walk leash apparatus arranged in accordance with the example embodiment of the present invention illustrated in FIG. 1;

FIG. 6 is a right side elevation view of the co-walk leash apparatus arranged in accordance with the example embodiment of the present invention illustrated in FIG. 1;

FIG. 7 is a top plan view of the co-walk leash apparatus arranged in accordance with the example embodiment of the present invention illustrated in FIG. 1;

FIG. 8 is a bottom plan view of the co-walk leash apparatus arranged in accordance with the example embodiment of the present invention illustrated in FIG. 1;

FIG. 9 is a perspective view of a co-walk leash apparatus in accordance with another example embodiment of the present invention;

FIG. 10 is another perspective view of the co-walk leash apparatus of FIG. 9, in a first configuration;

FIG. 11 is a perspective view of the co-walk leash apparatus of FIG. 9, in a second configuration, from the perspective of FIG. 10;

FIG. 12 is a perspective view of a co-walk leash apparatus in accordance with yet another example embodiment of the present invention;

FIG. 13 is a bottom plan view of the co-walk leash apparatus of FIG. 12; and

FIG. 14 is a top plan view of a co-walk leash apparatus in accordance with yet another example embodiment of the present invention.

### DETAILED DESCRIPTION OF THE ILLUSTRATED EMBODIMENTS

The following detailed description describes a co-walk leash apparatus, method of using and making the same and is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In order to more fully appreciate the present disclosure and to provide additional related features, each of the following references are fully incorporated herein by reference in their entirety:
(1) U.S. Pat. No. 7,497,186 discloses an animal self-carried hydrating system comprises an animal harness, a fluid container for holding the fluid, and a fluid dispensing mechanism. The animal harness is securable on the animal by a fastening system. The animal harness has a fluid pocket for holding the fluid container. The fluid dispensing mechanism is attached to the fluid container, in fluid communication with the fluid in the fluid container. The fluid dispensing mechanism is such that it can dispense fluid from the fluid container to the animal while the fluid container is in the fluid pocket.
(2) U.S. Pat. No. 9,241,474 teaches an animal harness for an animal that includes a loop of webbing, which encircles the back, neck and shoulder of the animal. A pouch is affixed to the loop. A pulsating device is disposed within the pouch and transmits same to the animal through the chest and about its heart to calm the animal during transport.
(3) U.S. Pat. No. 6,568,575 discloses a harness with detachable and interchangeable pouches comprises two torso straps extending downwardly and outwardly from a central coupler assembly, two shoulder straps, and two belly straps. The harness is adjustable to fit nearly any body size. The pouches are attached to the harness with quick-releasing retaining clips and to each other by the belly straps. Each pouch includes front and rear panels that are formed using either a right-side template or a left-side template and is interchangeable with any other pouch designed using the same template. The interchangeability allows the wearer to install pouches that are best suited for a particular activity. Each pouch is designed such that, when worn, it hangs at an angle which causes its top to slant downwardly toward the middle of the wearer's torso, thereby increasing the accessibility of the pouch contents.
(4) U.S. Pub. No. 2017/0215385 relates to a novel pet harness and pack for comfortably harnessing a dog and providing a dispenser for waste bags one on side of the harness and a storage pouch on the opposite side. The pouches are colorfully decorated with character faces and the bags will dispense out of a portion of the character's face. A metal loop is provided beneath a cross-stitched reinforced section of fabric wherein a leash may be attached to the harness.
(5) U.S. Pub. No. 2022/0079119teaches a retractable leash assembly for a pet animal, such as a dog. The leash assembly includes a casing body with a handle attached to the body by an at least one hinge joint, a braking device, and a spool arrangement with an extendable lead line wound thereabout and configured attachable to the pet animals' collar or harness, wherein in the leash assembly the handle is configured to articulate about the joint with regard to the casing body, the articulation movement of the handle being triggered by the pulling force exerted on the lead line by the animal kept on the leash, and wherein, by virtue of the articulation movement the braking device actuates a braking action causing the lead line to reduce unwinding speed proportionally with an increase in the pulling force.
(6) U.S. Pub. No. 2022/0167592 relates to a leash extender with a larger round wrist loop and a smaller round handle loop connected by an extension. A user will wrap the leash extender around the handle of a pet leash and pass the wrist loop through the handle loop and pull securely. The leash extender is made of a soft, flexible material and has no edges, so is very comfortable around the user's wrist.
(7) U.S. Pub. No. 2022/0125016 teaches a dog leash that includes a dog leash body. An end of the dog leash body is provided with an annulus structure and forms a traction part. The traction part is provided with a buckle by butt-and-collar joint. The root segment of the traction part is covered with a sheath. The dog leash adapts flexible steel wire rope with good flexibility and high strength. The steel wire rope is coated with plastic layer, which has good touch feeling and high use comfort.

Reference will now be made in detail to an embodiment of the present invention, example of which is illustrated in the accompanying drawings.

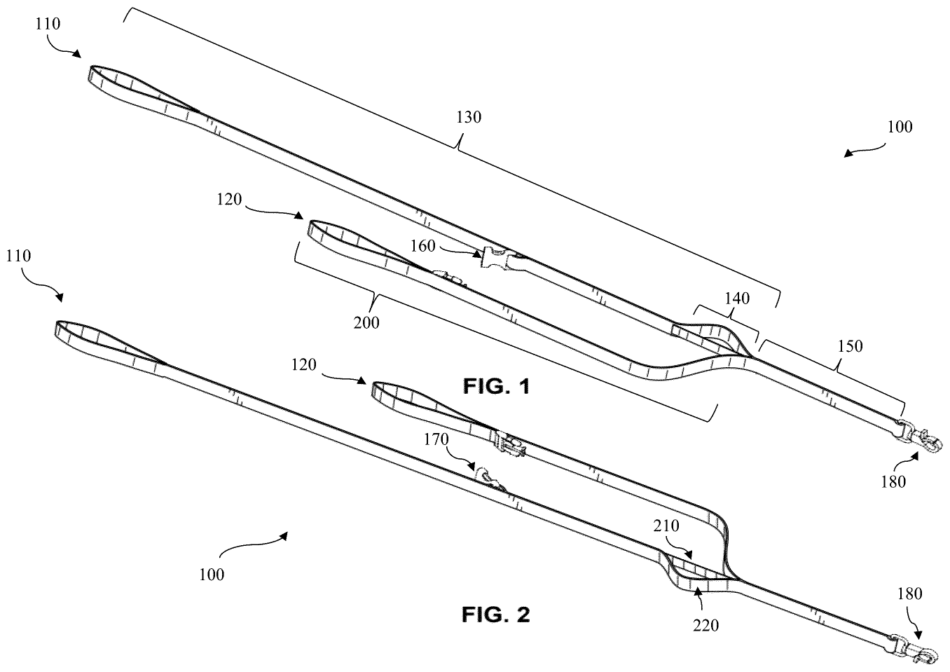

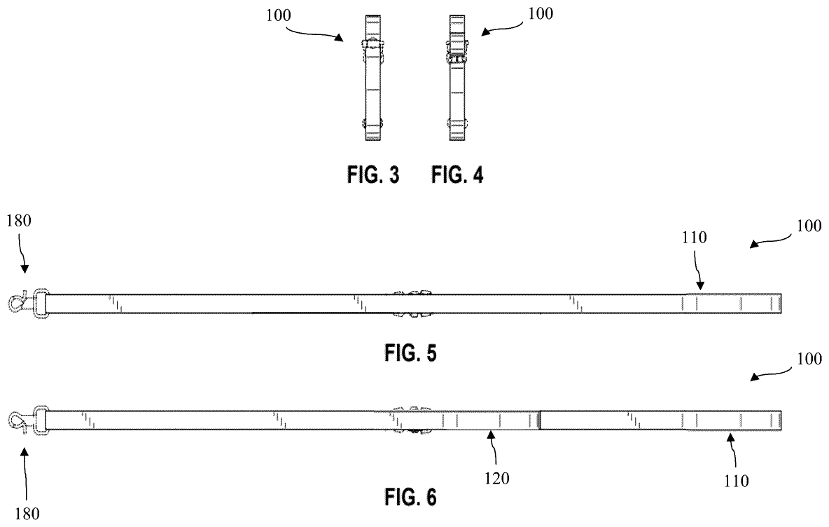

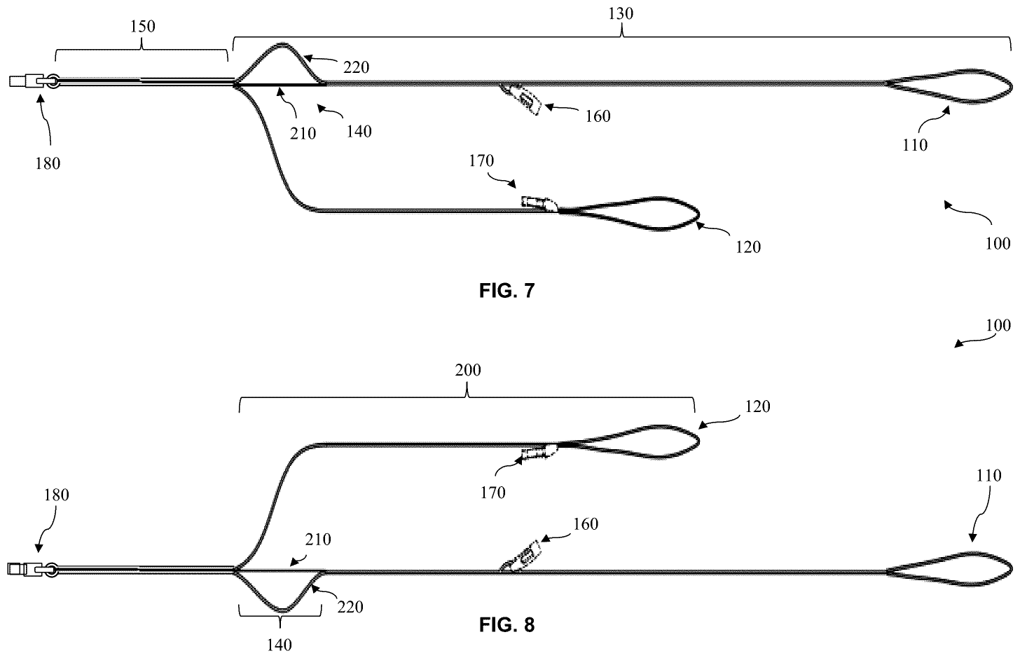

The present invention will now be discussed with reference to FIGS. 1-8, which illustrate various views of an example co-walk leash 100. The co-walk leash 100 is configured to be used either by two people (preferred) or one person to walk a dog. The co-walk leash has a harness connector 180 which attaches to a harness, collar or similar item worn by the dog to control and guide the movements of the dog.

The co-walk leash 100 includes a primary handle 110 and a secondary handle 120. In a preferred embodiment, the primary handle 110 is intended for a child and the secondary handle 120 is intended for an adult. However, in other embodiments, either handle 110, 120 may be used by an adult or child. In preferred embodiments, the handles 110, 120 are loops made from the same material as the rest of the co-walk leash 100 and sized to fit a human hand. In other embodiments, the handles are made of a different material from the rest of the co-walk leash 100. In one embodiment, the handles 110, 120 are the same size, while in another embodiment, the primary handle 110 (intended for a child) is smaller than the secondary handle 120 (intended for an adult). The handles 110, 120 may be of any desired size. In some embodiments, the handles 110, 120 are greater than four inches and/or less than 12 inches in diameter.

In a preferred embodiment, the primary handle 110 is connected (possibly made from the same material) to a top portion of a primary leash section 130. The secondary handle 120 is connected (possibly made from the same material) to a top portion of a secondary leash section 200. A bottom portion (or distal end) of the primary leash section 130 may be connected to a bottom portion (or distal end) of the secondary leash section 200.

The bottom portion of the primary leash section 130 and the bottom portion of the secondary leash section 200 may be connected to a top portion of a common leash section 150. A bottom portion of the common leash section 150 may be connected to a harness connector 180 (which may be attached to a harness or collar on the dog). In this manner 1) the primary handle 110 is connected to the primary leash section 130, which is connected to the common leash section 150, which is connected to the harness connection 180, which is connected to the dog harness or collar and 2) the secondary handle 120 is connected to the secondary leash 200, which is connected to the common leash section 150, which is connected to the harness connector 180, which is connected to the dog harness or collar. This gives both users some measure of control over the dog through their respective handles 110, 120.

The leash portions 130, 150, 200 making up the co-walk leash 100 may be made of any desired material. As non-limiting examples, the co-walk leash 100 may be made of leather, nylon, chain, cotton rope or any combination thereof. In a preferred embodiment, the co-walk leash 100 includes reflective stitching to provide for added visibility and safety.

The co-walk leash 100 may be of any desired lengths each from the primary handle 110 to the harness connector 180 and from the secondary handle 120 to the harness connector 180. In preferred embodiments, the length from the primary handle 110 to the harness connector 180 is greater than the length from the secondary handle 120 to the harness connector 180. This allows an adult to hold the secondary handle 120 and for the adult to have more control over the dog while also allowing a child, at the same time or overlapping times, to hold the primary handle 110 which requires less responsibility for the child in controlling the movements of the dog. In preferred embodiments the length from the primary handle 110 to the harness connector 180 is between six and 14 feet long while the secondary handle 120 to the harness connector 180 is between three and 10 feet long. In a most preferred embodiment, the primary handle 110 to the harness connector 180 is about 10 feet long while the secondary handle 120 to the harness connector 180 is about six feet long.

In embodiments as illustrated, a single strip of leash material, such as rope or nylon webbing, may be arranged in various ways to form some or all of the portions of the leash 100 in an integral manner. That is, the single strip of material may be attached to itself, such as by stitching or heat welding, at various points to define the leash 100 components. In other embodiments, the primary leash section 130 may be one continuous piece of material and the secondary leash section 200 may be one continuous piece of material. The respective continuous pieces may come together to form the common portion 150 and may together or separately attach to the harness connector 180.

In some embodiments, either or both of the primary leash section 130 and the secondary leash section 200 may include a shock absorbing section 140. As illustrated throughout FIGS. 1-8, a proximal portion of the primary leash section 130, approximate the common leash section 150, may include the shock absorbing section 140. The shock absorbing section 140 may be created by any desired means. As a non-limiting example, the shock absorbing section 140 may comprise an elastic section that has more elasticity than the rest of the primary leash section 130. The elastic section may be made of any elastic material, such as rubber or spring. Elastic material is hereby defined to be any material that returns to its original undamaged shape after being stretched by at least 10% by an external force.

The illustrated shock absorbing section 140 in FIGS. 1-8 includes a shorter elastic section 210 connected between a longer inelastic section 220 of the primary leash section 130. This allows the elastic section 210 to stretch and absorb an initial shock from any sudden or hard movements by the dog. The elastic section 210 may stretch to a maximum length that is the same as the length of the inelastic section 220 of the shock absorbing section 140, at which point the shock-absorbing function of the elastic section 210 is complete and the primary leash section 130 with a fully-extended inelastic section 220 operates like a normal leash.

While the shock absorbing section 140 may be located anywhere on the primary leash section 130, it is preferably near the bottom of the primary leash section 130. The shock absorbing section 140 reduces the tug or force on the primary handle 110 (handle intended in preferred embodiments to be used by a child) caused by the dog trying to move past the length of the co-walk leash 100. In some embodiments, the primary leash section 130 and the secondary leash section 200 both include a shock absorbing section 140 while in other embodiments only one of the sections 130, 200 or neither of the sections 130, 200 includes a shock absorbing section 140.

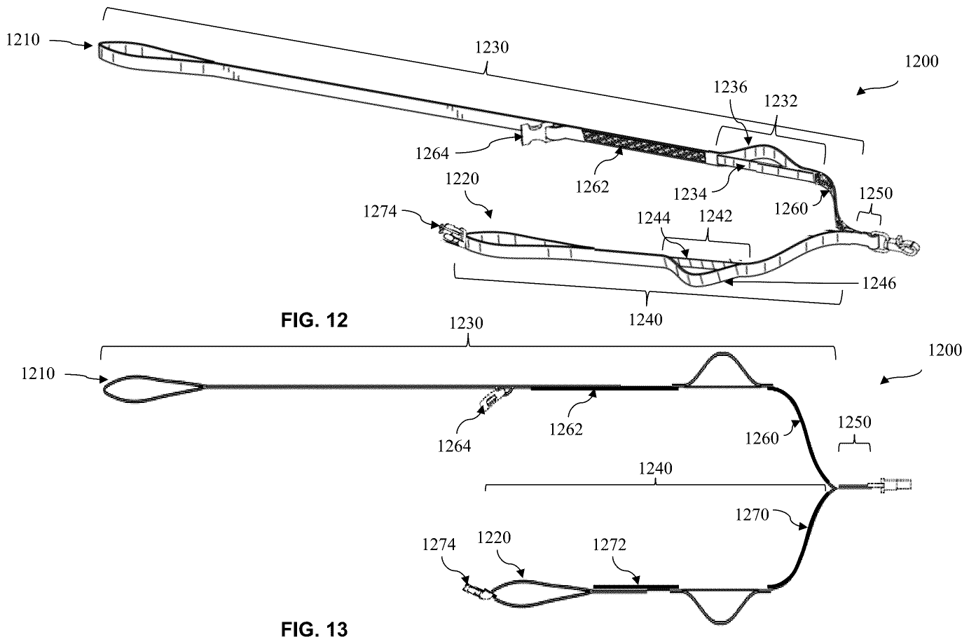

In some embodiments, a shock absorbing section 140 may be added near or at the distal end of either the primary leash section 130 or the secondary leash section 200 or to both sections. FIGS. 1-11 illustrate embodiments where the shock absorbing section 140 is only attached to the primary leash section 130. FIGS. 12-14 illustrate embodiments where a shock absorbing section is part of both the primary leash section and the secondary leash section, as described further below.

There may be times when the co-walk leash 100 is used by only one person to walk the dog. To accommodate this situation, in various embodiments the secondary leash section 200 may be attached to the primary leash section 130 and effectively stowed when either the primary handle 110 or secondary handle 120 is not in use. This avoids the situation of the handle 110, 120 that is not being used being dragged on the ground as the dog is being walked by a single person. In various embodiments, the primary leash section 130 and the secondary leash section 200 may each include means for the two leash sections 130, 200 to be connected to each other. Any desired means of connecting the primary leash section 130 with the secondary leash section 200 may be used. As non-limiting examples, Velcro strips, magnets, strips of cloth or rope ties, male and female button snaps, and male and female buckles may be used to connect the two leash sections 130, 200. As illustrated in FIGS. 1-8, a first part 160 of a mating quick-release buckle is attached to the primary leash section 130 and its mating second part 170 of the buckle is attached to the secondary leash section 200. When the primary leash section 130 and the secondary leash section 200 are attached to each other by connecting the parts 160, 170 of the buckle, the co-walk leash 100 is suitable for one person to easily walk the dog.

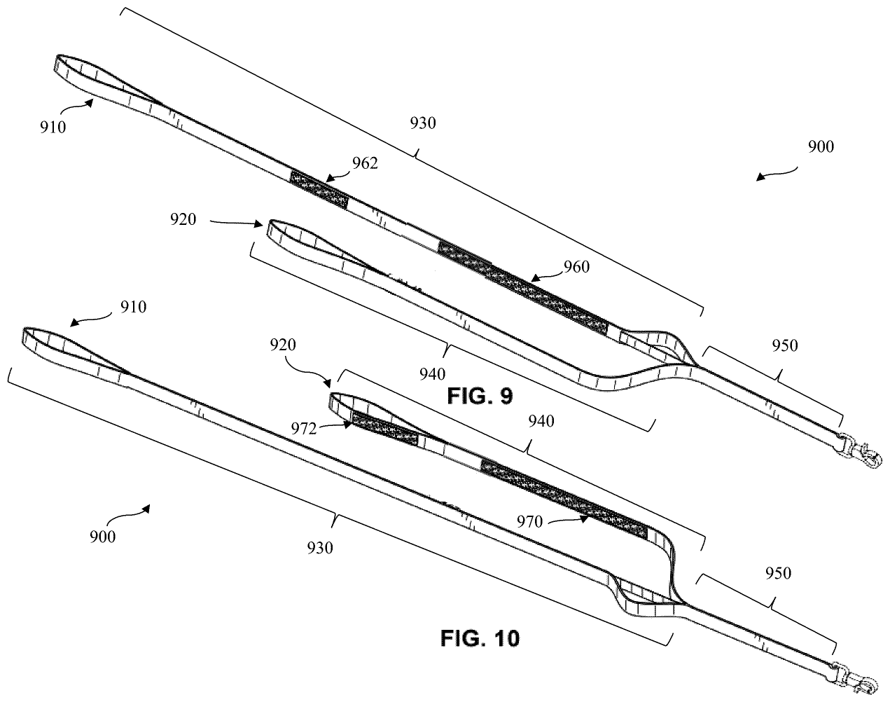

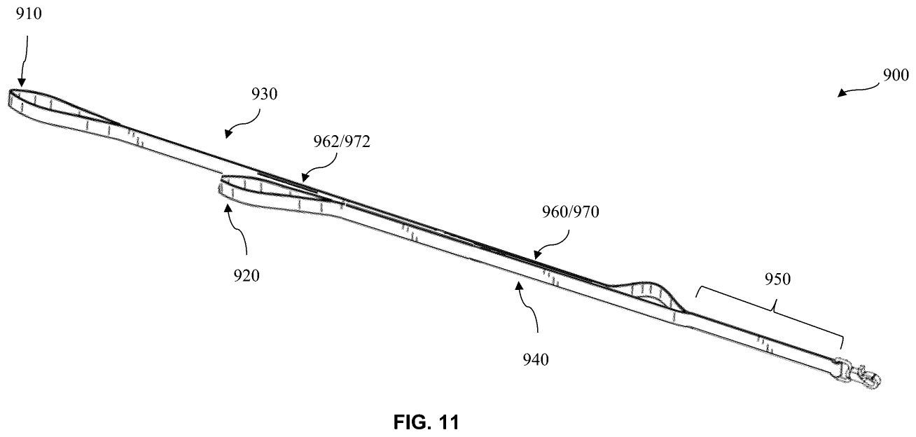

FIGS. 9-11 illustrate another example co-walk leash 900 that, in accordance with the present disclosure, provides another means for securing the two handled portions of the leash 900 to each other so a single person can easily use the leash 900. The leash 900 may include a primary handle 910, secondary handle 920, primary leash section 130, secondary leash section 940, common leash section 950, and other components (including those illustrated) that function as described above with respect to the corresponding components of co-walk leash 100. In addition to, or instead of, a buckle as described above, the leash 900 may include sections of Velcro, or other means for removably attaching the leash portions 930, 940 together, attached at advantageous locations to the inside surfaces of the primary leash section 930 and the secondary leash section 940. It will be understood that the mating sections (e.g., the “hook-side” and the “loop-side”) of such fasteners will be attached adjacent to each other relative to the respective lengths of the primary leash portion 930 and secondary leash portion 940 so that the mating sections attach to each other. For example, the leash 900 as illustrated may include a first fastening section 960, such as a strip of hook-side Velcro, near the proximal end of the primary leash section 930, and a second fastening section 962, also a strip of hook-side Velcro, at a location on the primary leash section 930 that corresponds approximately to the secondary handle 920; the leash 900 further includes corresponding first and second fastening sections 970, 972 attached to the secondary leash section 940 facing the first and second fastening sections 960, 962 of the primary leash section 930. This gives the options of connecting or not connecting any desired portions of the primary leash section 930 with the secondary leash section 940, as shown in FIG. 11.

FIGS. 12 and 13 illustrate another example co-walk leash 1200 that, in accordance with the present disclosure, provides for shock absorption along both of the handled portions of the leash 1200. The leash 1200 may include a primary handle 1210, secondary handle 1220, primary leash section 1230, secondary leash section 1240, common leash section 1250, and other components (including those illustrated) that function as described above with respect to the corresponding components of co-walk leash 100 and co-walk leash 900. The primary leash section 1230 may include a shock absorbing section 1232 formed by an elastic portion 1234 attached to points on the primary leash section 1230 adjacent to an inelastic portion 1236 of the primary leash section 1230 as described above with respect to the shock absorbing section 140 of the primary leash section 130 of co-walk leash 100. Additionally, the secondary leash section 1240 may also have a shock absorbing section 1242 configured in substantially the same manner as the shock absorbing section 1232 of the primary leash section 1230. In one embodiment, the shock absorbing section 1242 may be formed by an elastic portion 1244 attached to points on the secondary leash section 1240 adjacent to an inelastic portion 1246 of the secondary leash section 1240 as described above.

The co-walk leash 1200 may include fasteners for attaching the secondary leash section 1240 to the primary leash section 1230 to stow or shorten one or the other portion 1230, 1240 for safe walking of the dog. A first attaching section may be disposed between the common leash portion 1250 and the shock absorbing sections 1232, 1242; while other attachment means are contemplated as described herein, as illustrated the first attaching section is formed by mating Velcro portions 1260, 1270 on the respective leash portions 1230, 1240. A second attaching section may be formed distally from the shock absorbing sections 1232, 1242 using, for example, mating Velcro portions 1262, 1272 on the respective leash portions 1230, 1240. A third attaching section, such as a quick-release buckle having mating parts 1264, 1274 attached to the respective leash portions 1230, 1240, may ensure that the leash portions 1230, 1240 do not accidentally disengage from each other. The embodiments with Velcro (or other means of attachment) allow the length of the primary leash section 1230, the secondary leash section 1240, and the common leash section 1250, to be varied by adjusting (pressing different parts of the co-walk leash together) which portions of the respective fasteners are attached to each other.

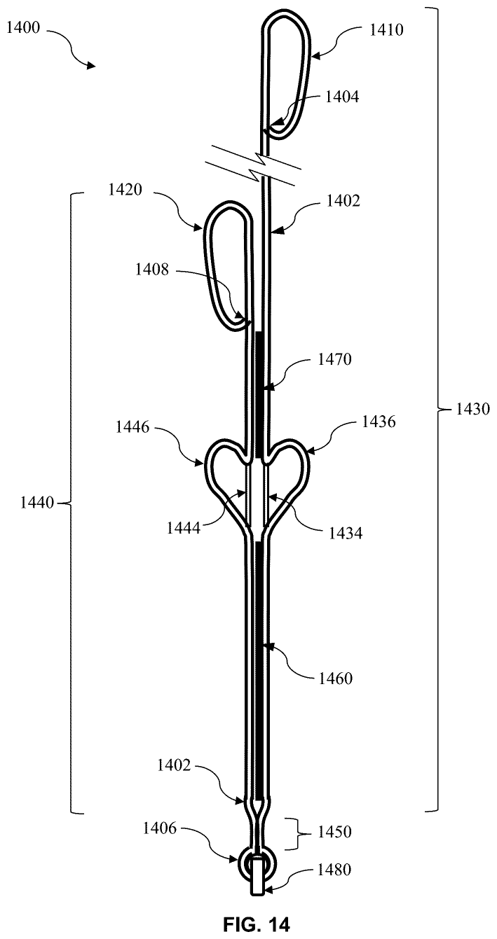

Referring to FIG. 14, an example co-walk leash 1400 as described herein may be formed using a single strip 1402 of leash material, such as rope or nylon webbing with temporary or permanent fastening of the strip 1402 to itself at various points to define the leash 1400 components. The leash 1400 may include a primary handle 1410, secondary handle 1420, primary leash section 1430, secondary leash section 1440, common leash section 1450, and other components (including those illustrated) that function as described above with respect to the corresponding components of any of the illustrated co-walk leashes 100, 900, 1200. In an example manufacturing configuration of the leash 1400 using a strip 1402 of leash material, at a first end 1404 the strip 1402 may attach to itself to form the primary handle 1410 at a distal end of the leash 1400; the strip 1402 then extends proximally through the primary leash section 1430 and the common leash section 1450 and attaches to a harness connector. For example, the strip 1402 may pass through a ring 1480 of the harness connector and then attach to itself to form, at a proximal end of the leash 100, a loop 1406 within which the ring 1480 of the harness connector is retained. The strip 1402 may then extend adjacent to itself distally through the common leash section 1450; in the illustrated embodiment, the strip 1402 is attached (e.g., by stitching), to itself at the overlapping portions in the common leash section 150. The strip 1402 further extends distally through the secondary leash section 1440, looping back and attaching to itself at a second end 1408 to form the secondary handle 120.

In various embodiments, the leash 1400 may include fastening and shock-absorption elements as described above. For example, both handled portions 1430, 1440 may include shock absorbing sections in which elastic strips 1434, 1444 are each attached at points on the strip 1402 to define inelastic portions 1436, 1446 of the strip 1402 that lend slack to the respective leash portions 1430, 1440. Temporary fasteners 1460, 1470 may be formed from mated parts (e.g., male/female snaps or buckle parts, Velcro strips, etc.) that are attached to the strip 1402 in a configuration that removably secures the leash portions 1430, 1440 to each other for stowage and/or shortening as described above. In an embodiment, the clastic strips 1434, 1444 may be selected with a length and elasticity so that, when the leash portions 1430, 1440 are attached to each other, the elastic strips 1434, 1444 are relaxed and the inelastic portions 1436, 1446 cooperate to form a heart shape, providing a visual indication that the leash portions 1430, 1440 are correctly joined together at the respective fasteners 1460, 1470.

The inventions and methods described herein can be viewed as a whole, or as a number of separate inventions, that can be used independently or mixed and matched as desired. All inventions, steps, processed, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A leash for two people to walk a dog, the leash comprising:
a primary leash section including a primary handle at a distal end of the primary leash section;
a secondary leash section including a secondary handle at a distal end of the secondary leash section, the secondary leash section being shorter than the primary leash section;
a common leash section attached to or integral with the primary leash section and the secondary leash section at a distal end of the common leash section; and
a harness connection disposed at a proximal end of the common leash section.

2. The leash of claim 1, wherein the primary leash section and the secondary leash section are each attached to or integral with the common leash section at a corresponding proximal end.

3. The leash of claim 1, wherein the primary leash section comprises a first shock absorbing section.

4. The leash of claim 3, wherein the first shock absorbing section comprises:
an elastic section that is designed to stretch; and
an inelastic section that is designed to resist stretching.

5. The leash of claim 3, wherein the secondary leash section comprises a second shock absorbing section.

6. The leash of claim 5, further comprising one or more fasteners configured to attach the primary leash section to the secondary leash section, the first and second shock absorbing sections being positioned so that, when the primary leash section is correctly attached to the secondary leash section, the first and second shock absorbing sections cooperate to form a heart shape within the leash.

7. The leash of claim 1, wherein the secondary leash section comprises a shock absorbing section.

8. The leash of claim 1, further comprising one or more fasteners configured to attach the primary leash section to the secondary leash section.

9. The leash of claim 8, wherein the one or more fasteners comprise a first mating part disposed on the primary leash section and a second mating part disposed on the secondary leash section, the second mating party removably attaching to the first mating part to form a buckle.

10. The leash of claim 8, wherein the one or more fasteners comprise a first Velcro strip disposed on the primary leash section and a second Velcro strip disposed on the secondary leash section and configured to removably attach to the first Velcro strip.

11. The leash of claim 10, wherein the second Velcro strip is disposed on the secondary handle.

12. The leash of claim 10, wherein the primary leash section comprises a first shock absorbing section and the first Velcro strip is disposed between the first shock absorbing section and the common leash section.

13. A leash for one or two people to walk a dog, the leash comprising:
a primary leash section;
a primary handle attached to or integral with the primary leash section at a distal end of the primary least section;
a secondary leash section shorter than the primary leash section;
a secondary handle attached to or integral with the secondary leash section at a distal end of the secondary leash section; and
a common leash section attached to or integral with the primary leash section and the secondary leash section, the common leash section configured to connect at a proximal end to a harness or collar of the dog.

14. The leash of claim 13, comprising a strip of leash material that defines the primary leash section, the common leash section, and the secondary leash section.

15. The leash of claim 14, wherein the strip of leash material further defines one or both of the primary handle and the secondary handle.

16. The leash of claim 14, wherein the strip of leash material:
attaches at a first end to itself to form the primary handle;
extends proximally from the primary handle to the proximal end of the common leash section;
extends distally from the proximal end of the common leash section, overlapping and attaching to itself to form the common leash section;
extends distally from a distal end of the common leash section to a second end of the strip; and
attaches at the second end to itself to form the secondary handle.

17. The leash of claim 13, further comprising one or more fasteners configured to attach the secondary leash section to the primary leash section at one or more points distal of the common leash section.

18. A method of controlling a dog, the method comprising:
attaching, to a collar or harness worn by the dog, a leash comprising:
a first leash section configured to connect at a proximal end to the harness or collar of the dog;
a second leash section attached to or integral with the first leash section and extending distally from a distal end of the first leash section;
a primary handle attached to or integral with the second leash section at a distal end of the second leash section;
a third leash section attached to or integral with the first leash section and extending distally from the distal end of the first leash section, the third leash section being shorter than the second leash section; and
a secondary handle attached to or integral with the third leash section at a distal end of the third leash section;
holding the primary handle by a less responsible user; and
holding the secondary handle by a more responsible user.

19. The method of claim 18, wherein the leash further comprises one or more fasteners configured to attach the third leash section to the second leash section at one or more points distal of the first leash section, the method further comprising:
attaching the one or more fasteners to stow the third leash section against the second leash section; and
holding the primary handle by the more responsible user such that the more responsible user controls the dog alone.
